(19) United States
(12) Patent Application Publication
(10) Pub. No.: US 2004/0250611 A1
(43) Pub. Date: Dec. 16, 2004

(54) Device for control of an electric fuel pump

(76) Inventor: Bernd Rumpf, Nidderau (DE)

Correspondence Address: Mayer Brown Rowe & Maw, 190 South La Salle Street, Chicago, IL, 60603-3441, US

(21) Appl. No.: 10/493,772

(22) PCT Filed: Oct. 10, 2002
(86) PCT No.: PCT/DE02/03821

(30) Foreign Application Priority Data
Nov. 1, 2001 (DE) 10153396.9

(51) Int. Cl. G01M 15/00

(52) U.S. Cl. 73/119 A

(57) ABSTRACT

The invention relates to a device for control of an electric fuel pump (1, 2) on a motor vehicle, whereby, on a fault in an electronic controller (3), the fuel pump (1, 2) is connected to the voltage supply of the vehicle. The fuel pump (1, 2) then pumps at full capacity. Said device offers a high security against a break in the supply of fuel.

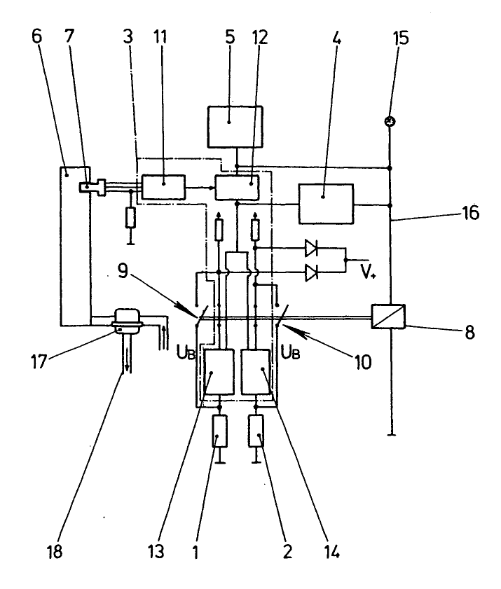

The invention relates to a device for actuating an electric fuel pump for a motor vehicle having an electronic controller for regulating the power of the fuel pump, said controller being arranged between a power supply and the fuel pump, and having a pressure sensor for monitoring a pressure which is generated by the fuel pump.

Such devices are used in motor vehicles today and are known from practice. As a result, the fuel pump can be regulated as a function of the demand of the internal combustion engine of the motor vehicle. The internal combustion engine therefore receives from the fuel pump only the quantity of fuel which it requires.

Unnecessary agitation and heating of fuel in the fuel container is avoided with the known device. As a result, the fuel container has a low level of permeation of fuel.

A disadvantage with the known device is that when the electronic controller fails the fuel pump is no longer actuated, and the fuel is thus not fed.

The invention is based on the problem of developing a device of the known type in such a way that when the electronic controller fails the fuel pump can continue to operate at least temporarily.

This problem is solved according to the invention in that the electronic controller is connected to a monitoring device, and in that means for connecting the fuel pump to the power supply when the electronic controller has a fault are provided.

As a result of this configuration, it is ensured that the fuel pump is supplied with power even when the electronic controller has a fault. The fuel pump therefore continues to operate despite the fault. As a result, when there is a fault in the electronic controller, a failure to supply the internal combustion engine with fuel is reliably avoided. The monitoring device may be, for example, what is referred to as a watch dog.

According to one advantageous development of the invention, when the pressure sensor fails it is ensured that the internal combustion engine is supplied with fuel if the electronic controller or the monitoring device has means for the unregulated connection of the fuel pump to the power supply when the pressure sensor has a fault.

The connection of the fuel pump to the power supply could have, for example, a standby controller. However, the device according to the invention is of particularly simple design if the connection to the power supply is unregulated.

The device according to the invention is of particularly simple structural design if the fuel pump has a switch, if the switch can be actuated by the monitoring device and is designed to connect the fuel pump to the electronic controller in one position, and to the power supply in the other position.

According to another advantageous development of the invention, the switching over from the regulated control of the fuel pump into the unregulated control requires particularly low structural expenditure if the switch has a relay.

In particularly high-power internal combustion engines, two fuel pumps are frequently used. According to another advantageous development of the invention, the regulation of the power of a plurality of fuel pumps requires particularly little expenditure if a single electronic controller is designed to actuate a plurality of fuel pumps.

The unregulated connection of the fuel pump could have, for example, a fixed resistance, and permit the fuel pump to operate in the partial load range. The device according to the invention permits permanent operation of the fuel pump under full load if the fuel pump is connected to a mechanical pressure regulator. By means of this configuration, the operation of the fuel pump with the unregulated connection to the power supply is the same as that of the known fuel pump without an electronic controller.

When there are a plurality of fuel pumps, a single switch could form the connection to the power supply or to the electronic controller. However, the device according to the invention has a particularly high level of failsafeness if each of the fuel pumps has its own switch.

According to another advantageous development of the invention, checking the operational capability of the electronic controller requires particularly low expenditure if the monitoring device and the control unit of the internal combustion engine have a common connection for a diagnostic device. At the same time, the electronic controller, the pressure regulator and the monitoring device can easily be tested using the control unit of the internal combustion engine which has to be checked regularly anyway.

The invention permits numerous embodiments. In order to clarify its basic principle further, one of them is illustrated in the drawing and will be described below.

The drawing shows, in a single FIGURE, a schematic view of a device according to the invention for regulating the power of two fuel pumps 1, 2. The device has an electronic controller 3 and a monitoring device 4. The electronic controller 3 is connected to a control unit 5 of an internal combustion engine of the motor vehicle and to a pressure sensor 7 which is arranged in an injection rail 6. As a result, the electronic controller 3 can regulate the power of the fuel pumps 1, 2 as a function of the signals of the control unit 5 and the pressure prevailing in the injection rail 6.

A signal which is generated by the electronic controller 3 is checked by the monitoring device 4. The monitoring device 4 is connected to a relay 8. The relay 8 actuates two switches 9, 10 which form the connection of the fuel pumps 1, 2 either to the power supply characterized in the drawing by V+ and ground, or to the electronic controller 3. The electronic controller 3 has a regulator 11, a pulse-width modulation means 12 and two control units 13, 14. The control units 13, 14 are each assigned to a fuel pump 1, 2.

The control unit 5 of the internal combustion engine and the monitoring device 4 are connected to a common diagnostic connection 15. In addition, the control signals of the monitoring device 4 are transmitted to the relay 8 via the line 16 which leads to the diagnostic connection 15.

A failure of the electronic controller 3 is sensed by the monitoring device 4. The monitoring device 4 actuates the relay 8 when the electronic controller 3 fails, and the said relay 8 then switches over the connection of the fuel pumps 1, 2 from the electronic controller 3 to the power supply. As a result, the fuel pumps 1, 2 are operated with full power in an unregulated fashion. The pressure generated by the fuel pumps 1, 2 is limited to, for example, 6 bar by a mechanical pressure regulator 17. Excess fuel is fed back into the fuel container via a cut-off line 18.

If the fuel pumps 1, 2 are regulated by means of the electronic controller 3, the pressure generated in the injection rail 6 is always held below 6 bar so that the mechanical pressure regulator 17 continuously closes the cut-off line 18.

1. A device for actuating an electric fuel pump for a motor vehicle having an electronic controller for regulating the power of the fuel pump, said controller being arranged between a power supply and the fuel pump, and having a pressure sensor for monitoring a pressure which is generated by the fuel pump, characterized in that the electronic controller (3) is connected to a monitoring device (4) and means for connecting the fuel pump (1, 2) to the power supply when the electronic controller (3) has a fault are provided.

2. The device as claimed in claim 1, characterized in that the electronic controller (3) or the monitoring device (4) has means for connecting the fuel pump (1, 2) to the power supply when the pressure sensor (7) has a fault.

3. The device as claimed in claim 1 or 2, characterized in that the connection of the fuel pump (1, 2) to the power supply is unregulated.

4. The device as claimed in at least one of the preceding claims, characterized in that the fuel pump (1, 2) has a switch (9, 10), in that the switch (9, 10) can be actuated by the monitoring device (4) and is designed to connect the fuel pump (1, 2) to the electronic controller (3) in one position, and to the power supply in the other position.

5. The device as claimed in at least one of the preceding claims, characterized in that the switch (9, 10) has a relay (8).

6. The device as claimed in at least one of the preceding claims, characterized in that a single electronic controller (3) is designed to actuate a plurality of fuel pumps (1, 2).

7. The device as claimed in at least one of the preceding claims, characterized in that the fuel pump (1, 2) is connected to a mechanical pressure regulator (17).

8. The device as claimed in at least one of the preceding claims, characterized in that each of the fuel pumps (1, 2) has its own switch (9, 10).

9. The device as claimed in at least one of the preceding claims, characterized in that the monitoring device (4) and the control unit (5) of the internal combustion engine have a common connection (15) for a diagnostic device.
